(19) United States
(12) Patent Application Publication
(10) Pub. No.: US 2008/0189729 A1
(43) Pub. Date: Aug. 7, 2008

(54) OPTICAL DISK DRIVE

(75) Inventors: Heyun Moon BANG, Suwon-si (KR); Won-Youl Bae, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/968,838

(22) Filed: Jan. 3, 2008

(30) Foreign Application Priority Data
Feb. 5, 2007 (KR) 2007-11867

(51) Int. Cl. G11B 7/08; G11B 7/09

(52) U.S. Cl. 720/692; 720/698

(57) ABSTRACT

An optical disk drive includes a damper interposed between a traverse deck having an optical pickup installed therein and a main frame having the traverse deck installed therein, thereby efficiently reducing vibration. The damper is installed in a coupling section between the traverse deck and the main frame to reduce a vibration and includes a through hole into which a boss formed in the main frame is inserted, and a support to protrude from inner circumference of the through hole such that the boss is fitted in the support.

### CROSS-REFERENCE TO RELATED APPLICATIONS

This application claims priority under 35 U.S.C. §119(a) Korean Patent Application No. 2007-11867, filed on Feb. 5, 2007, in the Korean Intellectual Property Office, the disclosure of which is incorporated herein by reference in its entirety.

### BACKGROUND OF THE INVENTION

1. Field of the Invention

The present general inventive concept relates to an optical disk drive, and more particularly, to an optical disk drive including a damper interposed between a traverse deck, on which an optical pickup is installed, and a main frame, on which the traverse deck is mounted, in order to efficiently reduce vibration.

2. Description of the Related Art

In general, an optical disk drive, such as a CD-ROM or a DVD player, records information on a disk by irradiating light onto the disk, which is a recording medium, or reads the information from the disk. The optical disk drive includes an optical pickup, which irradiates a laser beam onto a predetermined portion of the disk and picks up the reflected light, and driving devices, which rotate the disk and transfer the optical pickup.

In such an optical disk drive, the disk is rotated by a spindle motor, and the optical disk drive records the information or reproduces the recorded information along a track of the rotated disk by means of the optical pickup. Therefore, in order to accurately process data stored in the disk in high density, the optical pickup must be controlled such that the optical pickup can move along the track and accurately focus the laser beam on the disk track.

However, when an external force, such as vibration or impact, is applied to a traverse deck equipped with the optical pickup and the influence caused by the external force exceeds s control range of a servo used for tracking and focusing, an error may occur in recording and reproducing processes for the disk.

Therefore, in order to stably install the traverse deck on which the optical pickup is installed, a damper capable of damping an external disturbance such as vibration or impact is interposed between the traverse deck and a main frame supporting the traverse deck.

FIG. 1 is a longitudinal sectional view illustrating a damper 10 installed in a conventional optical disk drive, and FIG. 2 is a plan view illustrating the damper of FIG. 1.

The damper 10 comprises a through hole 11 at the center thereof to allow a boss (not shown) formed in a main frame to be inserted into the through hole 11. In addition, the damper 10 is provided at the bottom surface thereof with a plurality of protrusions 12 that allow the damper 10 to be deformed to perform a damping action in response to vibration or impact applied from a main frame (not illustrated) and a traverse deck 20 in a vertical direction.

The damper 10 having such a structure performs the damping action while moving up and down as the external vibration or impact is applied thereto.

At this time, the vibration or impact delivered to an optical disk drive from the exterior through the main frame includes horizontal components applied in a radial direction as well as vertical components applied in a longitudinal direction.

In addition, since a rotational center of a disk does not perfectly match with a centroid of the disk storing information, when the disk is rotated by a spindle motor, a differential centrifugal force is incurred in the disk, so the vibration occurs in the radial direction of the disk corresponding to an eccentric degree. As an RPM of the disk increases, the above phenomenon becomes serious, increasing the vibration in the radial direction.

However, even though the conventional damper 10 is capable of damping the vibration or impact applied in the longitudinal direction by using the protrusions 12 provided on a bottom of the damper 10, the conventional damper 10 is weak against the vibration or impact applied in the radial direction. In particular, as the optical disk drive supports a high-speed rotation, the disk can rotate at a high speed, so the conventional damper 10 is weaker against the vibration applied in the radial direction of the disk.

### SUMMARY OF THE INVENTION

The present general inventive concept provides an optical disk drive capable of effectively damping vibration applied to a disk in a radial direction as well as vibration applied to the disk in a longitudinal direction.

Additional aspects and/or advantages of the general inventive concept will be set forth in part in the description which follows and, in part, will be apparent from the description, or may be learned by practice of the general inventive concept.

The foregoing and/or other aspects and utilities of the present general inventive concept are achieved by providing an optical disk drive which include a traverse deck having an optical pickup installed therein, a main frame to form a main body and having the traverse deck installed therein, and at least one damper installed in a coupling section between the traverse deck and the main frame to reduce a vibration, wherein the damper includes a through hole into which a boss formed in the main frame is inserted, and a support to protrude along an inner circumference of the through hole such that the boss is fitted in the support.

A coupling groove may be formed in an outer circumference of the damper to assemble the damper with an installation hole formed in the traverse deck, and the support is formed in a radially inward direction of the coupling groove.

The support may have an inner diameter smaller than an outer diameter of the boss such that the support is overlapped with the boss.

The support may have a width identical to a thickness of the traverse deck, and is aligned together with the traverse deck on a same plane.

The coupling groove may have an outer diameter greater than an inner diameter of the installation hole such that the coupling groove is overlapped with the installation hole.

The inner diameter of the support may be smaller than the outer diameter of the boss by about 0.15 mm to about 0.3 mm.

The outer diameter of the coupling groove may be greater than the inner diameter of the installation hole by about 0.1 mm to about 0.2 mm.

The damper may include a rim which is bent at a lower part of the support in a radially outward direction of the support in order to reduce the vibration applied in an axial direction.

The damper may further include protrusions at an upper part thereof to dampen the vibration applied to the damper in an axial direction.

The foregoing and/or other aspects and utilities of the present invention general inventive concept are also achieved by providing an optical disk drive including a main frame, a traverse deck installed with an optical pickup, and at least one damper installed in a coupling section between the traverse deck and the main frame to absorb a vibration, wherein the damper includes a portion to correspond to the coupling section and to have an elastic restoring force when the portion of the damper is installed in the coupling section.

The portion of the damper may include a first shape as an original shape and a second shape when the portion of the damper is inserted into the coupling section so as to generate the elastic restoring force.

The portion of the damper may have another elastic force to absorb the vibration transmitted from one of the main frame and the traverse deck

The main frame may include a boss, and the damper may be inserted around the boss of the main frame and may include the portion to correspond to the coupling section, and to have a first thickness when the damper is not inserted into the coupling section, and a second thickness thinner than the first thickness when the portion of the damper is inserted into the coupling section.

The main frame may include a boss, the damper may include an inner circumference to define a through hole to accommodate the boss, and the portion may protrude from the inner circumference of the damper to have the first thickness and the second thickness in the coupling section.

The main frame may include a boss, and the damper may include a through hole which is defined by an inner circumference of the damper and into which the boss of the main frame is inserted, and a support to protrude from the inner circumference toward an inside of the through hole such that the boss is fitted in the support.

The main frame may include a boss, the traverse deck may include a side wall to define an installation hole to receive the boss and the damper, and the damper may be inserted between the boss and the traverse deck from one of the main frame and the traverse deck, and may include the portion and another portions disposed upper and lower sides of the portion to be spaced-apart from the boss.

The optical disk drive may further include a screw unit to couple the damper to the main frame when the damper is dispose between the traverse deck and the main frame, and the damper may have the elastic restoring force in the coupling section in a direction and another force in another direction when the screw unit couples the damper to the man frame.

The main frame may include a boss, and the screw unit may be coupled to the boss to couple the damper to the main frame, and the screw unit does not contact another portion of the main frame.

The damper may include another portion having a thickness thinner than a thickness of the portion of the damper in a radial direction.

The foregoing and/or other aspects and utilities of the present invention general inventive concept are also achieved by providing an n optical disk drive including a main frame having a boss, a traverse deck installed with an optical pickup, and at least one damper installed in a coupling section between the traverse deck and the boss of the main frame to absorb a vibration, wherein the damper may include a portion having an elastic restoring force to contact the traverse deck and the boss of the main frame in the coupling section when the portion of the damper is installed in the coupling section, and another portion disposed on one of upper and lower side of the portion to be spaced-apart from the boss.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a longitudinal sectional view illustrating a damper installed in a conventional optical disk drive;

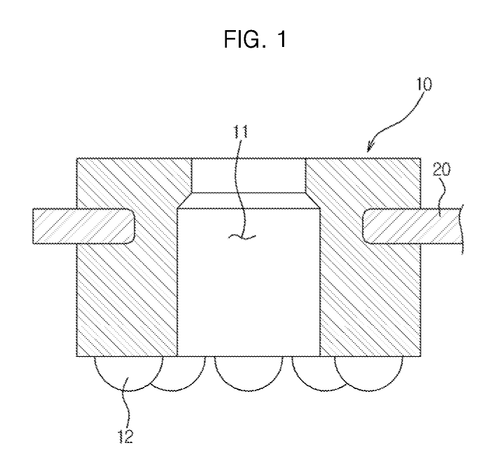

FIG. 2 is a plan view illustrating the damper of FIG. 1;

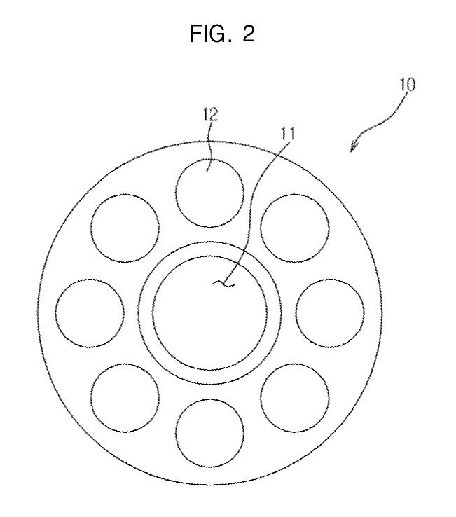

FIG. 3 is a schematic perspective view illustrating an internal structure of an optical disk drive according to an embodiment of the present general inventive concept;

FIG. 4 is a longitudinal sectional view illustrating a damper and an installation structure thereof according to the embodiment of the present general inventive concept; and

FIG. 5 is a plan view illustrating the damper of FIG. 4.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

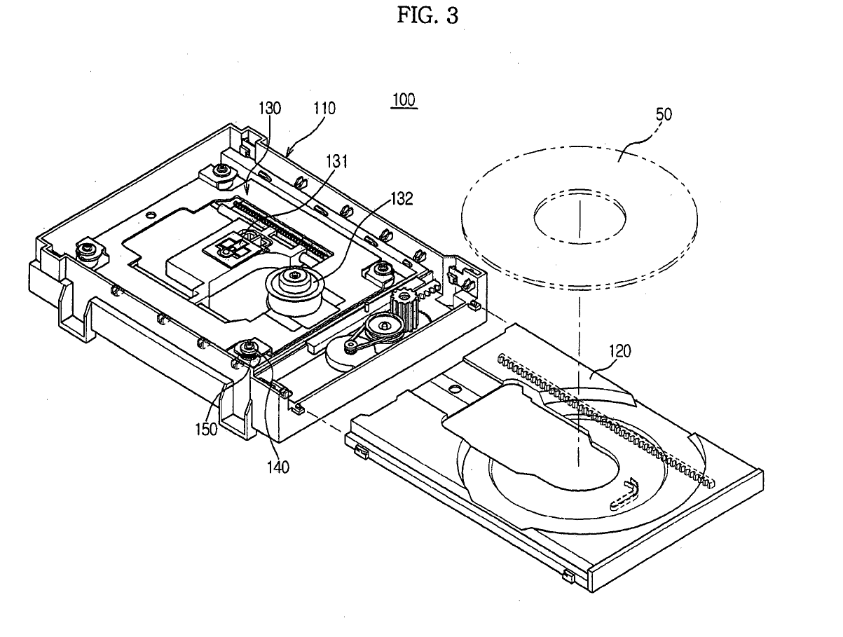

FIG. 3 is a schematic perspective view illustrating an internal structure of a disk drive apparatus, such as an optical disk drive 100, according to an embodiment of the present general inventive concept.

Referring to FIG. 3, the optical disk drive 100 includes a main frame 110 forming a main body, and a traverse deck 130 installed inside the main frame 110.

The main frame 110 includes a tray 120 to transfer a disk 50. The tray 120 slides in and out through the opened front portion of the main frame 110 to load/unload the disk 50.

The traverse deck 130 includes a turntable 132, on which the disk 50 is placed, and an optical pickup 131, which records information on the disk 50 or reproduces the information from the disk 50 while moving in a radial direction of the disk 50 placed on the turntable 132.

Therefore, the disk 50 is transferred by the tray 120, and then placed on the turntable 132. Then, the disk 50 is rotated together with the turntable 132, and the optical pickup 131 records the information on the rotating disk 50 or reproduces the information from the disk 50 while moving relative to the disk 50.

A rotational center of the disk 50 may not perfectly match with a centroid of the disk 50 in the process of manufacturing the optical disk drive 100. If the disk 50 is rotated at a high speed under the above state, vibration occurs in the traverse deck 130.

Therefore, in order to dampen the vibration caused by the rotation of the disk 50, and to block the vibration applied to the disk 50 from the exterior, a damper 150 is installed in a coupling section between the main frame 110 and the traverse deck 130 to reduce the vibration.

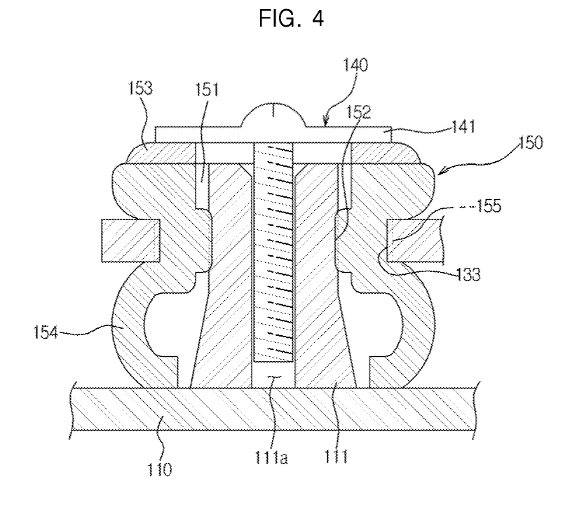

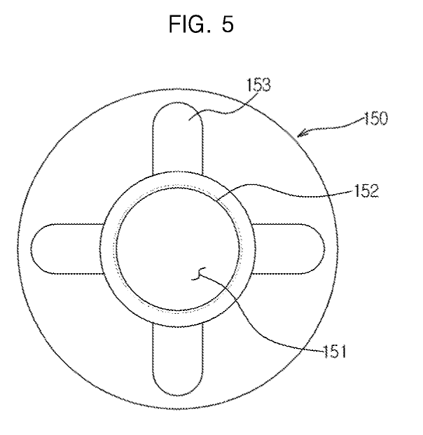

FIG. 4 is a longitudinal sectional view illustrating a damper and an installation structure thereof in an optical disk drive according to an embodiment of the present, and FIG. 5 is a plan view illustrating the damper of FIG. 4.

Referring to FIGS. 3, 4, and 5, a boss 111 is formed on the main frame 110 so that the main frame 110 is coupled with the damper 150, and the damper 150 is formed with a through hole 151 into which the boss 111 is inserted. The through hole 151 is defined by an inside wall of the damper 150

In addition, the traverse deck 130 include an installation hole 133 defined by a side wall of the traverse deck 130 such that the traverse deck 130 is coupled with the damper 150, and a coupling groove 155 is formed in a portion of an outer circumference of the damper 150 to form a coupling structure with the inside wall of the traverse deck 130 when the side wall of the traverse deck 130 defining the installation hole 133 is disposed in the coupling groove 155.

A support 152 is formed on a portion of an inner circumference of the damper 130 to protrude from the inner circumference of the damper 130 toward an inside of the through hole 151, and an outer circumference of the boss 111 makes contact with a side wall of the support 152. The damper 150 include an elastic material, such as rubber.

The portion of the inner circumference of the damper 130 formed with the support 152 can correspond to the portion of the outer circumference of the damper 130 formed with the coupling groove 155. For example, the traverse deck 130 may be coupled to the boss 111 through the damper 130, that is, the coupling groove 155 of the outer circumference and the support 152 of the portion of the inner circumference of the damper 130.

The damper 130 can have an original shape having a thickness between the portion of the inner circumference of the damper 130 formed with the support 152 and the portion of the outer circumference of the damper 130 formed with the coupling groove 155 in a direction in which the traverse deck 130 is disposed, when the damper is not disposed between the boss 111 and the traverse deck 130, and can also have another shape having a thickness different from the thickness of the original shape when the damper is disposed between the boss 111 and the traverse deck.

The portion of the inner circumference of the damper 130 formed with the support 152 can have a first length in a direction in which the boss 11 is formed to protrude from the main frame 110, and the portion of the outer circumference of the damper 130 formed with the coupling groove 155 can have a second length different from the first length of the portion of the inner circumference of the damper 130 formed with the support 152. The first length of the portion of the inner circumference of the damper 130 formed with the support 152 may be longer than a thickness of the traverse deck 130.

The inner circumference of the damper 130 may have the other portion on which the support 152 is not formed, and the other portion of the inner circumference of the damper 130 may be spaced-apart from the boss 111 by a certain distance. The outer circumference of the damper 130 may have the other portion on which the coupling groove 155 is not formed, and the other portion of the outer circumference of the damper 130 may be spaced-apart from the traverse deck 130. It is possible that predetermined areas of the other portions of the outer circumference of the damper 130 may contact upper and bottom surfaces of the traverse deck 130.

The damper 130 may have an upper portion and a lower portion disposed on an upper side and a lower side of the portions of the inner and outer circumferences of the damper 130. The upper portion and the lower portion may have different thicknesses from the thickness of the portions of the inner and outer circumferences of the damper 130.

The support 152 is formed in a radially inward direction to correspond to the coupling groove 155 while being aligned together with the traverse deck 130 on the same plane, such that the support 152 can dampen vibration applied to the damper 150 in the radial direction from the traverse deck 130.

A damping (dampening) operation of the support 152 of the damper 150 can be improved by allowing the boss 111 to closely make contact with the support 152. At this time, since an inner diameter of the support 152 is smaller than an outer diameter of the boss 111, the support 152 is coupled with the boss 111 while being pressed by means of an elastic restoring force, so that prestress is applied by the support 152, thereby improving the damping operation of the support 152. The elastic restoring force may be generated by a difference between the inner diameter of the support 152 and the outer diameter of the boss 111.

However, since an overlapping degree between the support 152 and the boss 111 becomes greater as a size difference between the inner diameter of the support 152 and the outer diameter of the boss 111 increases, the support 152 deformed by the vibration may not return to its original state because of the Coulomb force when the support 152 is not pressed toward the boss 111 using a predetermined amount of the elastic restoring force. In this case, the support 152 may fail to perform the damping operation. For this reason, the overlapping degree between the support 152 and the boss 111 is set in a predetermined range, for example, from about 0.15 mm to about 0.3 mm.

When assembling the coupling groove 155 of the damper 150 with the side wall of the traverse deck 130 defining the installation hole 133, an outer diameter of the coupling groove 155 of the damper 150 is set to be greater than an inner diameter of the side wall of the traverse deck 130 defining the installation hole 133 such that the prestress can be applied, similar to the coupling between the support 152 and the boss 111.

Here, as described above, the overlapping degree between the coupling groove 155 and the installation hole 133 may be in a predetermined range that does not interrupt the damping operation even if the Coulomb force is applied thereto. It is possible that the overlapping degree between the coupling groove 155 of the damper 150 and the side wall of the traverse deck 130 is set in a range, for example, from about 0.1 mm to about 0.2 mm.

As the optical disk drive 100 rotates at a high speed, an RPM of the disk 50 increases, and a centrifugal force induced by the rotation of the disk 50 increases in proportion to a square of the RPM of the disk 50. Accordingly, the optical disk drive 100 rotating at the high speed has a problem of incurring the vibration caused by the centrifugal force of the disk 50.

The above-mentioned damping (or dampening) structure having the support 152 and the coupling groove 155 is to dampen the vibration applied in the radial direction of the damper 150, that is, the vibration applied in the horizontal direction of the traverse deck 130. The support 152 is formed in the radially inward direction of the coupling groove 155 to form a surface making contact with the boss 111. At this time, the support 152 has a width substantially identical to a thickness of the traverse deck 130.

As the disk 50 rotates, the vibration in the radial direction of the disk 50 is delivered to the traverse deck 130 through the turntable 132, so that the traverse deck 130 is vibrated in the horizontal direction thereof. According to the damping structure having the support 152 and the coupling groove 155, the section interposed between the traverse deck 130 and the boss 111 is subject to the prestress state, thereby dampening the vibration of the traverse deck 130 caused by the disk 50 rotating at the high speed.

Hereinafter, the damping structure which performs the damping operation in response to the vibration applied in the axial direction of the damper 150 will be described.

The damper 150 includes protrusions 153 at an upper part thereof, thereby dampening the vibration applied in the axial direction of the damper 150.

The protrusions 153 are radially disposed, and the protrusions 153 are spaced apart from each other along the circumference of an upper surface of the damper 150.

Meanwhile, a female screw hole 111A is formed at the upper end portion of the boss 111, and the screw hole 111A is coupled with a screw 140 which is a coupling member.

A washer 141 is provided at the upper part of the screw 140 to make a contact surface with the protrusions 153 while supporting the upper part of the damper 150.

In addition, the damper 150 includes a rim 154, which is bent at a lower part of the support 152 in the radially outward direction.

The protrusions 153 and the rim 154 are to reduce the axial vibration. The protrusions 153 are elastically deformed to perform the damping operation in response to the vibration mainly caused by a movement generated between the washer 141 and the traverse deck 130. The rim 154 is elastically deformed to perform the damping operation in response to the vibration mainly caused by the movement generated between the traverse deck 130 and the main frame 110.

Here, when the screw 140 is coupled with the damper 150 through the screw hole 111A, the damper 150 can be pressed by the washer 141 corresponding to the depth of the screw 140 inserted into the screw hole 111A. Accordingly, the prestress can be applied in the axial direction of the damper 150.

A distal end of the screw 140 may not contact the main frame 110, so that the screw 140 does not affect the damping operation of the damper 150. The damper 150 is pressed between the washer 141 of the screw 140 and the main frame 110 and between the boss 111 and the traverse deck 130. It is possible that the distal end of the screw 140 contact the main frame 110 to increase a coupling between the boss 111 and the main frame 110. The lower portion of the damper 150 may contact the main frame 110.

The boss 111 may have an outer diameter varying in a direction in which the boss 111 is formed on the main frame 110. The outer diameter of the boss may have a first diameter to correspond to the portion of the damper 150 formed with the coupling groove 155 and the support 152, and a second diameter to correspond to the lower portion of the damper 150, such that the damper 140 can easily inserted around the boss 111.

As described above, the optical disk drive according to the present general inventive concept includes the damper interposed between the boss of the main frame and the traverse deck. The damper includes the structure capable of damping the vibration applied in the radial direction of the damper as well as the vibration applied in the axial direction of the damper. The damper further include the support, which forms the surface that makes contact with the boss, inside the through hole. In addition, the coupling groove and the support, which form the coupling structure between the traverse deck and the boss, are coupled with each other in the prestress state.

Accordingly, the optical disk drive having the damper according to the present general inventive concept can effectively dampen the vibration applied in the radial direction of the disk, even if the disk is rotated at the high speed. As a result, the optical disk drive can be stably operated.

Although few embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. An optical disk drive comprising:
a traverse deck having an optical pickup installed therein;
a main frame to form a main body, to be installed with the traverse deck installed therein, and to be installed with a boss; and
at least one damper installed in a coupling section between the traverse deck and the main frame to reduce a vibration,
wherein the damper comprises:
a through hole which is defined by an inner circumference of the damper and into which the boss formed in the main frame is inserted; and
a support to protrude from the inner circumference toward an inside of the through hole such that the boss is fitted in the support.

2. The optical disk drive of claim 1, wherein:
the traverse deck comprises a side wall to define an installation hole;
the damper comprises a coupling groove formed in an outer circumference of the damper to assemble the damper with the side wall defining the installation hole of the traverse deck; and
the support is formed in a radially inward direction of the coupling groove.

3. The optical disk drive of claim 2, wherein the support has an inner diameter smaller than an outer diameter of the boss such that the support is overlapped with the boss.

4. The optical disk drive of claim 2, wherein the support has a width identical to a thickness of the traverse deck, and is aligned together with the traverse deck on a same plane.

5. The optical disk drive of claim 2, wherein the coupling groove has an outer diameter greater than an inner diameter of the installation hole such that the coupling groove is overlapped with the installation hole.

6. The optical disk drive of claim 3, wherein the inner diameter of the support is smaller than the outer diameter of the boss by about 0.15 mm to about 0.3 mm.

7. The optical disk drive of claim 5, wherein the outer diameter of the coupling groove is greater than the inner diameter of the installation hole by about 0.1 mm to about 0.2 mm.

8. The optical disk drive of claim 1, wherein the damper comprises a rim which is bent at a lower part of the support in a radially outward direction of the support in order to reduce the vibration applied in an axial direction.

9. The optical disk drive of claim 1, wherein the damper further comprises protrusions at an upper part thereof to dampen the vibration applied to the damper in an axial direction.

10. An optical disk drive comprising:
a main frame;
a traverse deck installed with an optical pickup; and
at least one damper installed in a coupling section between the traverse deck and the main frame to absorb a vibration,
wherein the damper comprises a portion to correspond to the coupling section and to have an elastic restoring force when the portion of the damper is installed in the coupling section.

11. The optical disk drive of claim 10, wherein the portion of the damper comprises a first shape as an original shape and a second shape when the portion of the damper is inserted into the coupling section so as to generate the elastic restoring force.

12. The optical disk drive of claim 10, wherein the portion of the damper has another elastic force to absorb the vibration transmitted from one of the main frame and the traverse deck.

13. The optical disk drive of claim 10, wherein:
the main frame comprises a boss; and
the damper is inserted around the boss of the main frame and comprises a portion to correspond to the coupling section, and to have a first thickness when the damper is not inserted into the coupling section, and a second thickness thinner than the first thickness when the portion of the damper is inserted into the coupling section.

14. The optical disk drive of claim 10, wherein:
the main frame comprises a boss;
the damper comprises an inner circumference to define a through hole to accommodate the boss; and
the portion protrudes from the inner circumference of the damper to have the first thickness and the second thickness in the coupling section.

15. The optical disk drive of claim 10, wherein:
the main frame comprises a boss: and
the damper comprises:
a through hole which is defined by an inner circumference of the damper and into which the boss of the main frame is inserted; and
a support to protrude from the inner circumference toward an inside of the through hole such that the boss is fitted in the support.

16. The optical disk drive of claim 10, wherein:
the main frame comprises a boss;
the traverse deck comprises a side wall to define an installation hole to receive the boss and the damper; and
the damper is inserted between the boss and the traverse deck from one of the main frame and the traverse deck, and comprises the portion and another portions disposed upper and lower sides of the portion to be spaced-apart from the boss.

17. The optical disk drive of claim 10, further comprising:
a screw unit to couple the damper to the main frame when the damper is dispose between the traverse deck and the main frame,
wherein the damper has the elastic restoring force in the coupling section in a direction and another force in another direction when the screw unit couples the damper to the man frame.

18. The optical disk drive of claim 17, wherein the main frame comprises a boss, and the screw unit is coupled to the boss to couple the damper to the main frame, and the screw unit does not contact another portion of the main frame.

19. The optical disk drive of claim 10, wherein the damper comprises another portion having a thickness thinner than a thickness of the portion of the damper in a radial direction.

20. An optical disk drive comprising:
a main frame having a boss;
a traverse deck installed with an optical pickup; and
at least one damper installed in a coupling section between the traverse deck and the boss of the main frame to absorb a vibration,
wherein the damper comprises a portion having an elastic restoring force to contact the traverse deck and the boss of the main frame in the coupling section when the portion of the damper is installed in the coupling section, and another portion disposed on one of upper and lower side of the portion to be spaced-apart from the boss.
